(19) United States
(12) Patent Application Publication
(10) Pub. No.: US 2014/0072263 A1
(43) Pub. Date: Mar. 13, 2014

(54) OPTICAL FIBER ADAPTER HAVING VERTICAL WINGS

(71) Applicant: ALLIANCE FIBER OPTIC PRODUCTS, INC., NEW TAIPEI CITY (TW)

(72) Inventors: JUI-YANG HUNG, NEW TAIPEI CITY (TW); YEN-HSU LIN, TAIPEI HSIEN (TW)

(21) Appl. No.: 13/939,405

(22) Filed: Jul. 11, 2013

Related U.S. Application Data
(60) Provisional application No. 61/743,646, filed on Sep. 10, 2012.

(51) Int. Cl. G02B 6/38

(52) U.S. Cl. CPC G02B 6/3825
USPC 385/60

(57) ABSTRACT

An optical fiber adapter includes an adapter body defining multiple first accommodation chambers and second accommodation chambers in opposing first mating portion and second mating portion thereof, a partition wall disposed between the first accommodation chambers and the second accommodation chambers, coupling portions respectively extended from the partition wall into the first accommodation chamber and the second accommodation chamber and two wings respectively vertically extended from opposing top and bottom sides of the partition wall, and ferrules respectively mounted in the coupling portions for guiding the optical fiber cores of each two respective optical fiber connectors into abutment for transmitting an optical signal. Subject to the design of the wings, a large number of optical fiber adapters can be closely mounted in a device housing having a limited width and height.

### REFERENCE TO RELATED APPLICATION

This reference is based on Provisional Application Serial No. 61/743,646, filed 10 Sep. 2012, currently pending.

### BACKGROUND OF THE INVENTION

1. Field of the Invention

The present invention relates to optical fiber technology, and more particularly to an optical fiber adapter, which has wings respectively vertically extended from opposing top and bottom sides of a middle partition wall between opposing first mating portion and second mating portion thereof. Subject to the design of the wings, a large number of optical fiber adapters can be installed in the housing of a server, industrial computer, optical fiber splice box, digital junction box, optical fiber terminal box or any other optical fiber equipment and closely arranged in a vertical or horizontal line, achieving excellent optical space allocation arrangement.

2. Description of the Related Art

Following fast development of communication and internet technology, telephone and network facilities are widely used for data transmission and real time communication, bringing great convenience to people. In a communication system, cables are used for transmitting electrical signal or optical signal. The transmission of optical signal is faster than the transmission of electrical signal. Optical fiber cables are commonly used for transmitting optical signal. Further, optical fiber cables have the advantages of strong anti-electromagnetic interference, anti-noise ability, wide bandwidth, light weight, long distance transmission and good privacy.

Further, many different types of optical fiber connectors are commercially available. The most widely used optical fiber connectors are SC (subscriber/square/standard) connectors and LC (lucent/local/little) connectors. A LC (lucent/local/little) connector shrinks the size of ferrules to 1.25 mm in diameter with a fiber pitch of 6.25 mm. Two LC simplex connectors can be joined to form a duplex connector. LC optical fiber connectors are low cost, reliable and can be easily installed to terminate fiber optic cables. Further, LC optical fiber connectors provide simplex and duplex transmission flexibility.

Further, optical fiber adapters are equipped with ferrules for alignment and connection between mating optical fiber connectors. These ferrules can be made of ceramics or copper, and are adapted to act as alignment mechanisms. They have the advantages of high dimensional precision, high mechanical durability, low insertion loss and low reflective loss, minimizing optical signal loss. As shown in FIGS. 8 and 9, a conventional optical fiber adapter is a two-piece design, comprising a front shell member A, a rear shell member B, and two ferrules C. The front shell member A and the rear shell member B each comprise two accommodation chambers A1/B1, two side wings A2/B2 respectively bilaterally disposed at the rear side thereof, and two locating holes All/B11 located on the back wall thereof. The two ferrules C are respectively inserted through the locating holes A11/B11. Further, the front shell member A and the rear shell member B are joined together, and then the side wings A2/B2 are bonded together by ultrasonic welding. During application, optical fiber connectors are respectively mounted in the accommodation chambers A1/B1, and the optical fiber cores of the optical fiber connectors are respectively aligned and connected in the ferrules C for transmitting optical signals.

Normally, LC optical fiber adapters are installed in the face panel of the housing of a server. A 1U server is a standard one rack unit server of low cost, low energy consumption and small size. Multiple 1U servers can be densely installed in a machine room, or constructed to form an industrial computer for particular application purposes. To satisfy maximum space arrangement requirements, server manufacturers are trying hard to fully utilize the limited face panel installation space for the installation of a large number of optical fiber adapters for alignment and connection of more optical fiber connectors.

According to conventional techniques, the rear shell members B of optical fiber adapters are mounted in the server housing D and arranged in parallel to abut the side wings B2 against the front surface of the server housing D, and the metal spring leaves or clips at the two opposite lateral sides of the rear shell members B are forced into engagement with the inside wall of the server housing D. According to this prior art design, the abutted side wings A2/B2 of each two adjacent optical fiber adapters have a width about d=2.6 mm. Thus, the side wings A2/B2 occupy much surface area of the server housing. Achieving optical fiber adapter high mounting density is the common goal of optical fiber adapter manufacturers. However, according to the aforesaid prior design, a gap of d=2.6 mm is left between each two adjacent optical fiber adapters, high density installation and optical space allocation arrangement cannot be achieved. In consequence, the available space of the server housing D cannot be fully utilized for mounting optical fiber adapters in a relatively higher density. Thus, less number of transmission channels can be provided in the server housing D of a standard 1U server, resulting in bandwidth restriction.

Therefore, it is desirable to provide an optical fiber adapter that eliminates the aforesaid problems.

### SUMMARY OF THE INVENTION

The present invention has been accomplished under the circumstances in view. It is therefore the main object of the present invention to provide an optical fiber adapter, which allows a relatively larger number of optical fiber adapters to be closely mounted in the housing of a server, industrial computer, optical fiber splice box, digital junction box, optical fiber terminal box or any other optical fiber equipment for the connection of optical fiber connectors of an optical fiber communication system or network system.

To achieve this and other objects of the present invention, an optical fiber adapter comprises an adapter body and a plurality of ferrules. The adapter body defines multiple first accommodation chambers and second accommodation chambers in opposing first mating portion and second mating portion thereof, a partition wall disposed between the first accommodation chambers and the second accommodation chambers, coupling portions respectively extended from the partition wall into the first accommodation chamber and the second accommodation chamber and two wings respectively vertically extended from opposing top and bottom sides of the partition wall. The ferrules are respectively mounted in the coupling portions for guiding the optical fiber cores of each two respective optical fiber connectors into abutment for transmitting an optical signal. The structural design of the wings allows the adapter bodies of multiple optical fiber adapters to be installed in the housing of a server and closely arranged in a vertical or horizontal line, achieving optical space allocation arrangement.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of an optical fiber adapter in accordance with the present invention.

FIG. 2 is an exploded view of the optical fiber adapter in accordance with the present invention.

FIG. 3 corresponds to FIG. 1 when viewed from another angle.

FIG. 4 is a sectional side view of the optical fiber adapter in accordance with the present invention.

FIG. 5 is a schematic drawing illustrating an application example of the optical fiber adapter in accordance with the present invention.

FIG. 6 is a schematic drawing illustrating another application example of the optical fiber adapter in accordance with the present invention.

FIG. 7 is oblique top elevational view of an alternate form of the optical fiber adapter in accordance with the present invention.

FIG. 8 is an exploded view of an optical fiber adapter according to the prior art.

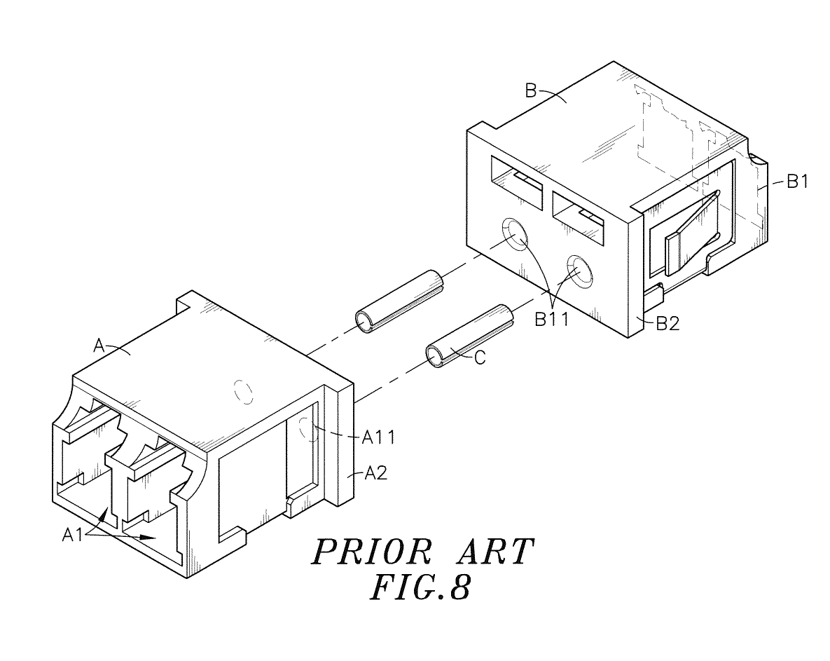

FIG. 9 is a schematic drawing illustrating an application example of the prior art optical fiber adapter.

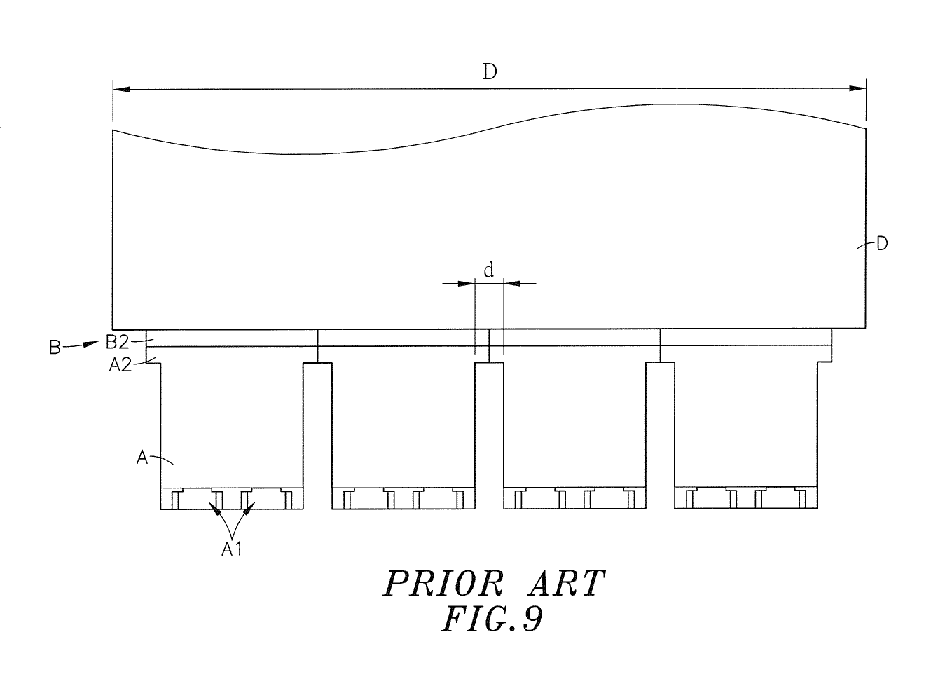

### DETAILED DESCRIPTION OF THE PREFERRED EMBODIMENT

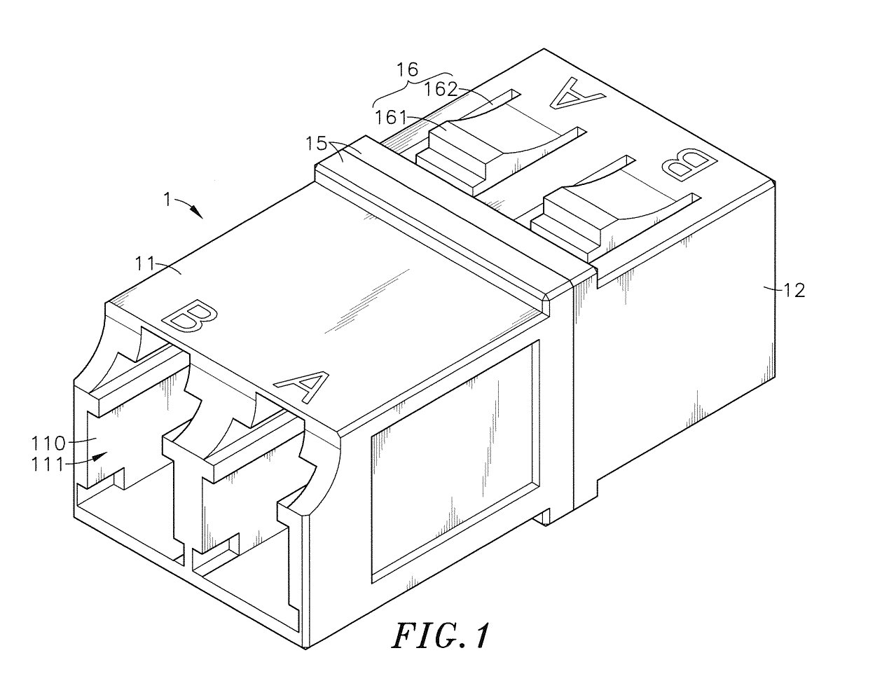

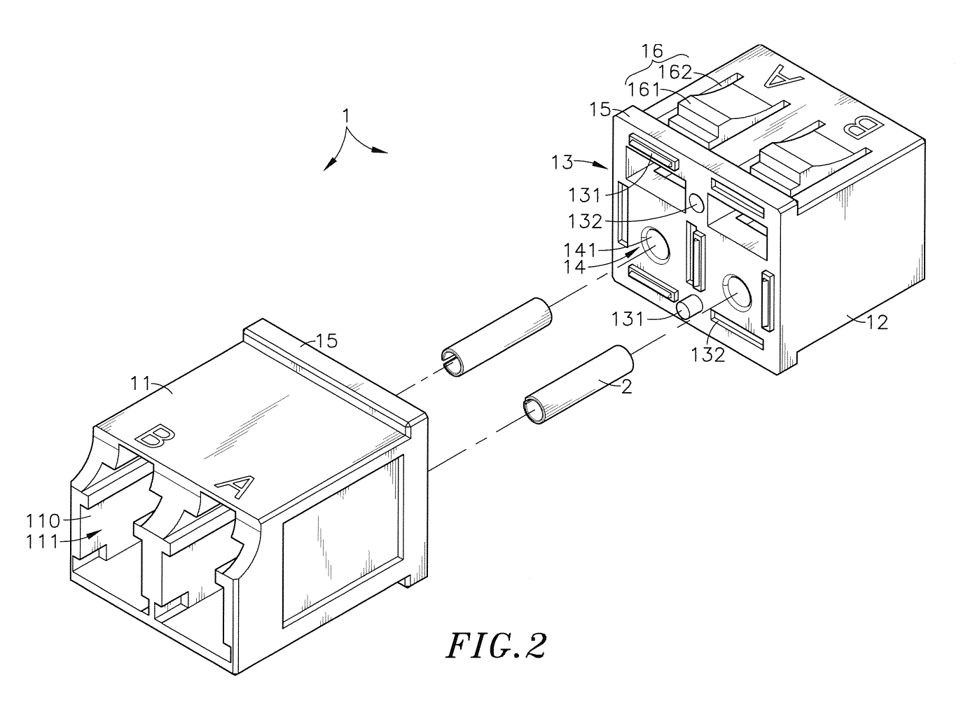

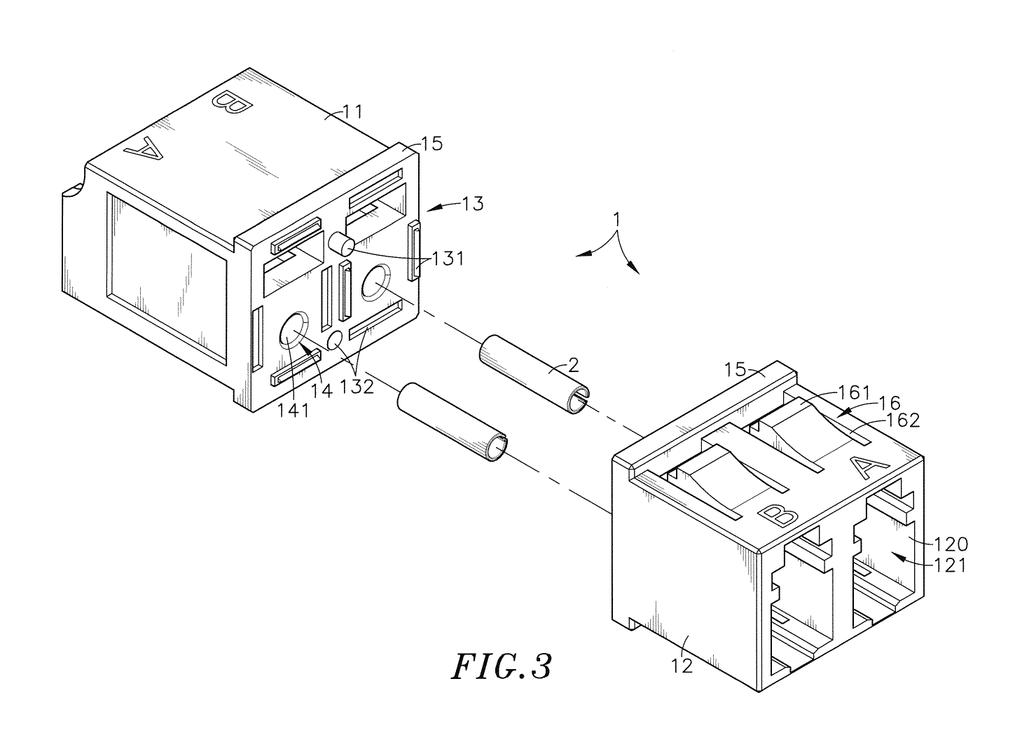

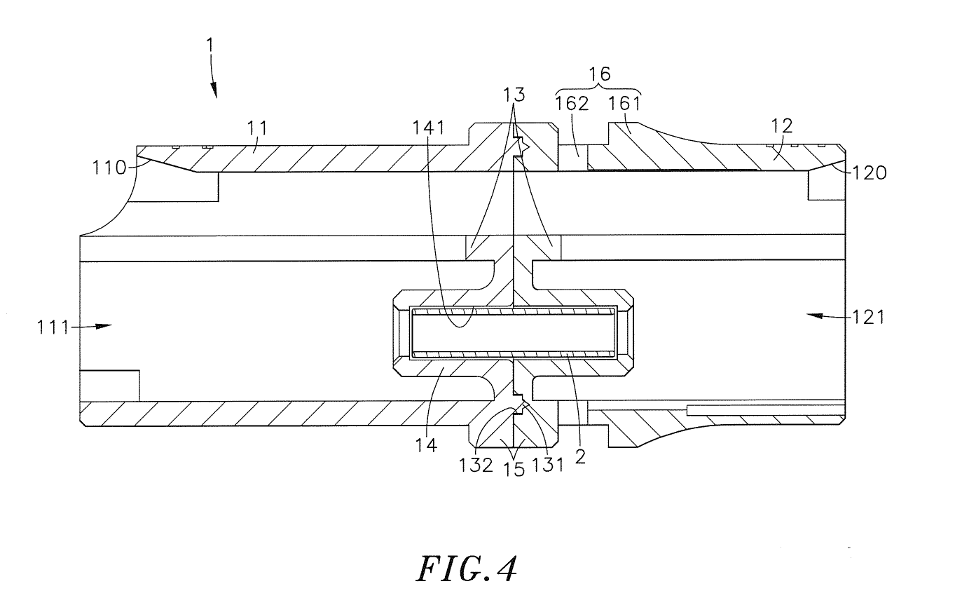

Referring to FIGS. 1-4, an optical fiber adapter in accordance with the present invention is shown. The optical fiber adapter comprises an adapter body 1, and a plurality of ferrules 2.

The adapter body 1 comprises a first mating portion 11 and a second mating portion 12 for the insertion of optical fiber connectors, at least one first accommodation chamber 111 defined in the first mating portion 11, at least one second accommodation chamber 121 defined in the second mating portion 12, an insertion hole 110 or 120 in communication between each first accommodation chamber 111 or second accommodation chamber 121 and the surroundings, at least one, for example, two partition walls 13 disposed on the middle between the at least one first accommodation chamber 111 and the at least one second accommodation chamber 121, and a plurality of coupling portions 14 respectively extended from the partition walls 13 toward the inside of each respective first accommodation chamber 111 or second accommodation chamber 121 and defining therein a respective passage hole 141 for accommodating the ferrules 2. Thus, external optical fiber connectors can be respectively inserted into the at least one first accommodation chamber 111 and the at least one second accommodation chamber 121, enabling the optical fiber core of each optical fiber connector to be inserted into the passage hole 141 of one respective ferrule 2 and abutted against the optical fiber core of a mating optical fiber connector for transmitting optical signal.

Further, each partition wall 13 has two wings 15 respectively vertically extended from the opposing top and bottom sides thereof and respectively protruding over the top or bottom wall of the first mating portion 11 or second mating portion 12. The adapter body 1 further comprises a fastening structure 16 located on the top wall of the second mating portion 12. The fastening structure 16 comprises at least one, for example, two clips 161 formed integral with the top wall of the second mating portion 12, and a crevice 162 cut through the top wall of the second mating portion 12 around each clip 161 to enhance flexibility of the respective clip 161.

According to this embodiment, the adapter body 1 is made out of a plastic material by insert molding. Alternatively, copper, zinc alloy or any other metal material can be selectively used to make the adapter body 1. Preferably, the first mating portion 11 and the second mating portion 12 are separately made and then fastened together. In one example of the present invention, the first mating portion 11 and the second mating portion 12 are separately made out of a plastic material, each having one partition wall 13 disposed at the rear side thereof, two wings 15 respectively vertically extended from the opposing top and bottom sides of the partition wall 13, and a plurality of plug rods 131 and plug holes 132 located on the partition wall 13. By means of plugging the plug rods 131 of the first mating portion 11 or second mating portion 12 into the plug holes 132 of the second mating portion 12 or first mating portion 11, the partition wall 13 and wings 15 of the first mating portion 11 are respectively abutted against the partition wall 13 and wings 15 of the second mating portion 12. Thereafter, ultrasonic welding technique is employed to seal the wings 15 of the first mating portion 11 and the wings 15 of the second mating portion 12, thereby joining the first mating portion 11 and the second mating portion 12. If a metal material is used to make the adapter body 1, the first mating portion 11 and the second mating portion 12 can be made in one piece, or separately made and then fastened together. If the first mating portion 11 and the second mating portion 12 are separately made, they can be joined together by welding, laser welding, riveting, or any other fastening means.

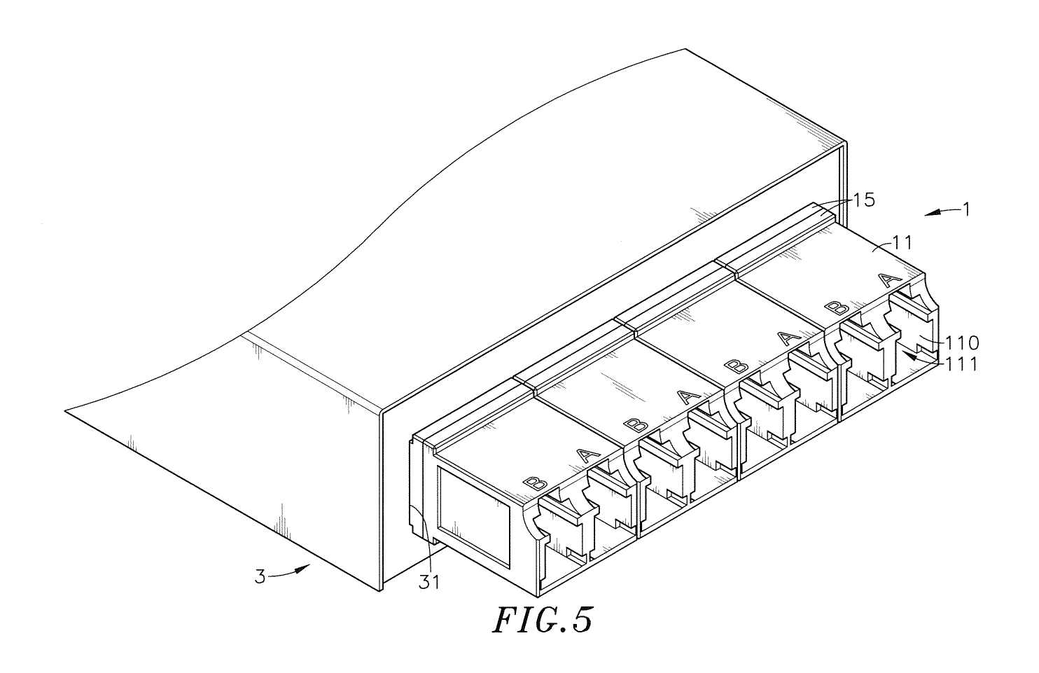

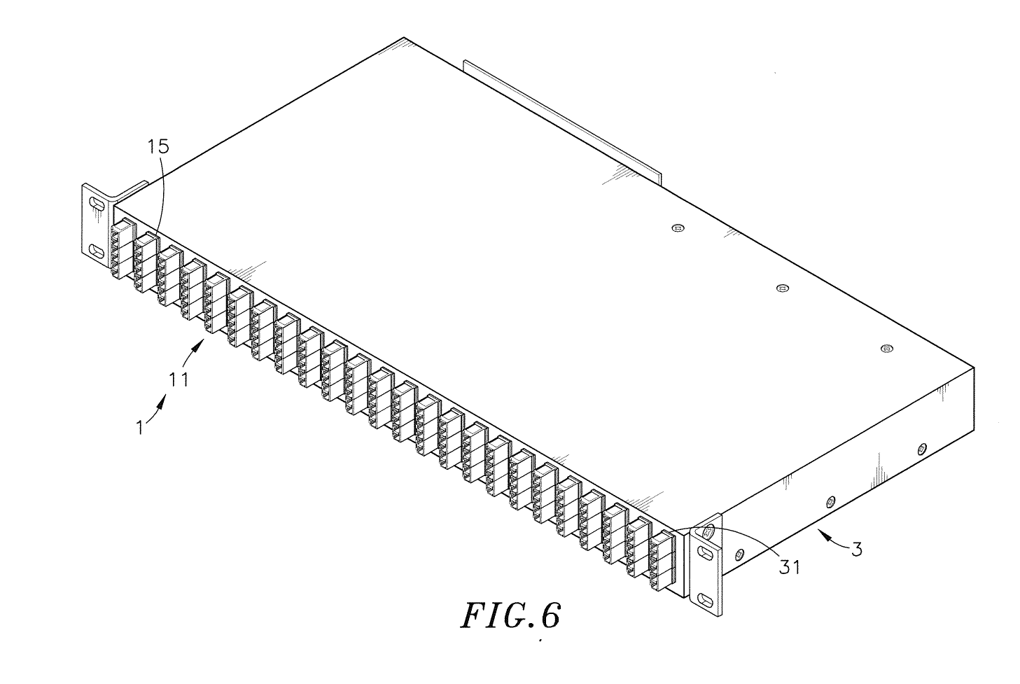

Referring to FIGS. 5 and 6, two application examples of the optical fiber adapter in accordance with the present invention are illustrated. As illustrated, the optical fiber adapter of the present invention is practical for installation in the housing 3 of a server, industrial computer, optical fiber splice box, digital junction box, optical fiber terminal box or any other optical fiber equipment for the connection of optical fiber connectors of an optical fiber communication system or network system.

During installation, horizontally insert the second mating portion 12 of the adapter body 1 into one mounting hole 31 on the face panel of the housing 3 to force the clips 161 of the fastening structure 16 into engagement with the inside wall of the mounting hole 31. When inserting the second mating portion 12 into the mounting hole 31, the clips 161 of the fastening structure 16 will be elastically deformed. After the clips 161 of the fastening structure 16 have been moved into the inside of the mounting hole 31, the clips 161 immediately return to their former shape and are stopped at an inside edge inside the mounting hole 31. After installation, the face panel of the housing 3 is retained between the wings 15 of the adapter body 1 and the clips 161 of the fastening structure 16, and the adapter body 1 is prohibited from displacement relative to the housing 3. Thus, subject the design of wings 15 and fastening structure 16, a large number of optical fiber adapters can be rapidly and firmly installed in the housing 3 and closely arranged in a horizontal line (see FIG. 5) or in vertical lines (see FIG. 6). Thus, the invention allows installation of a relatively larger number of optical fiber adapters in a standard size of housing 3.

It is to be understood that the above-described embodiment is simply an example of the present invention but not intended for use as limitations. If the invention is used in the housing 3 of a 1U (one rack unit) server, the size of the housing 3 is 48.26 cm×4.445 cm. In this case, 24×3=72 optical fiber adapters (see FIG. 6) can be installed in the housing 3. When compared to the prior art design where only 24×2=48 optical fiber adapters can be installed in the housing D of a 1U (one rack unit) server, the invention fully utilizes the installation of the server housing. The structural design of the wings 15 allows the adapter bodies 1 of multiple optical fiber adapters to be installed in the housing of a server and closely arranged in a vertical or horizontal line, achieving optical space allocation arrangement.

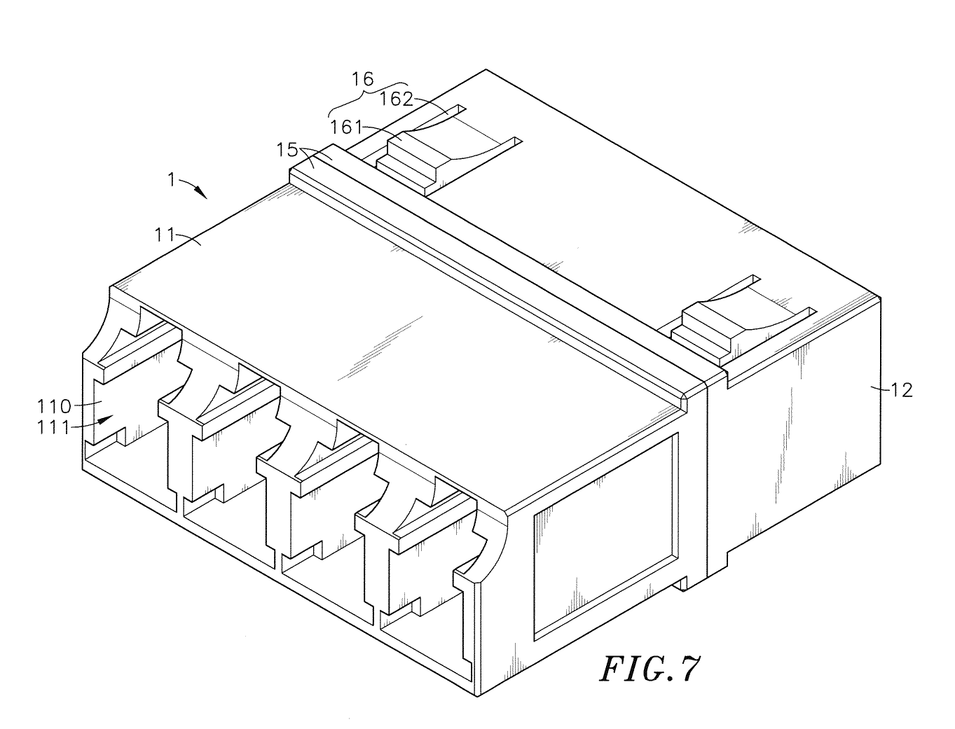

In the embodiment shown in FIGS. 1-3, two first accommodation chambers 111 and two second accommodation chambers 121 are respectively defined in the first mating portion 11 and the second mating portion 12. In actual application, this accommodation chamber design is not a limitation. In an alternate form of the present invention, as shown in FIG. 7, four first accommodation chambers 111 and four second accommodation chambers 121 (not shown) are respectively defined in the first mating portion 11 and second mating portion 12 of the adapter body 1. In this case, four ferrules 2 (not shown) are respectively mounted in between the four first accommodation chambers 111 and the four second accommodation chambers 121 for guiding the optical fiber cores of four mating pairs of optical fiber connectors into abutment, improving the practicability and range of applicability of the optical fiber adapter. Further, the optical fiber adapter of the present invention has low insertion loss and reflective loss, assuring a high level of optical signal transmission reliability and enhancing product competitiveness.

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. An optical fiber adapter, comprising:
an adapter body, said adapter body comprising a first mating portion and a second mating portion for the insertion of optical fiber connectors, at least one first accommodation chamber defined in said first mating portion, at least one second accommodation chamber defined in said second mating portion, at least one partition wall disposed between said at least one first accommodation chamber and said at least one second accommodation chamber, a plurality of coupling portions respectively extended from said partition walls into said first accommodation chamber and said second accommodation chamber, each said coupling portion and defining therein a passage hole, and two wings respectively vertically extended from opposing top and bottom sides of each said partition wall; and
a plurality of ferrules respectively mounted in the passage holes of said coupling portions for guiding optical fiber cores of two respective optical fiber connectors into abutment for transmitting an optical signal.

2. The optical fiber adapter as claimed in claim 1, wherein said adapter body is selectively made out of plastics, copper or zinc alloy.

3. The optical fiber adapter as claimed in claim 1, wherein said first mating portion and said second mating portion of said adapter body are separately made and then joined together.

4. The optical fiber adapter as claimed in claim 3, wherein said first mating portion and said second mating portion each have one respective said partition wall located at a rear side thereof, the partition wall at said first mating portion comprising a plurality of plug rods and a plurality of plug holes, the partition wall at said second mating portion comprising a plurality of plug holes and a plurality of plug rods and respectively forced into engagement with the plug rods and plug holes of the partition wall at said first mating portion.

5. The optical fiber adapter as claimed in claim 3, wherein the wings at the partition wall at said first mating portion and the wings at the partition wall at said second mating portion are joined together by ultrasonic welding.

6. The optical fiber adapter as claimed in claim 1, wherein said first mating portion and said second mating portion of said adapter body are made in one piece.

7. The optical fiber adapter as claimed in claim 1, wherein said adapter body further comprises a fastening structure located on a top wall of said second mating portion, said fastening structure comprising at least one clip formed integral with said top wall of said second mating portion.

8. The optical fiber adapter as claimed in claim 7, wherein said fastening structure further comprises a crevice cut through said top wall of said second mating portion around each said clip.
